(19) United States
(12) Patent Application Publication
(10) Pub. No.: US 2025/0070923 A1
(43) Pub. Date: Feb. 27, 2025

(54) DATA TRANSMISSION METHOD, FIRST DEVICE, AND SECOND DEVICE

(71) Applicant: GUANGDONG OPPO MOBILE TELECOMMUNICATIONS CORP., LTD., Dongguan (CN)

(72) Inventors: Bingxue LENG, Dongguan (CN); Qianxi LU, Dongguan (CN); Boyuan ZHANG, Dongguan (CN)

(21) Appl. No.: 18/943,807

(22) Filed: Nov. 11, 2024

Related U.S. Application Data
(63) Continuation of application No. PCT/CN2022/093529, filed on May 18, 2022.

(51) Int. Cl. H04L 1/1867; H04L 1/08

(52) U.S. Cl. CPC H04L 1/189; H04L 1/08

(57) ABSTRACT

A data communication method includes: transmitting, by the first device, first data on a sidelink in a duplication transmission mode.

### CROSS-REFERENCE TO RELATED APPLICATION

This application is a Continuation Application of PCT/CN2022/093529 filed May 18, 2022, which is incorporated herein by reference in its entirety.

### TECHNICAL FIELD

The application relates to the communication field, and more specifically, to a data communication method, a first device, and a second device.

### BACKGROUND

With the development of communication technologies, mobile communication systems will not only support conventional communication, but will also support, for example, device to device (D2D) communication, machine to machine (M2M) communication, machine type communication (MTC), vehicle to vehicle (V2V) communication, or vehicle to everything (V2X) communication.

A long term evolution (LTE) system may implement duplication communication in V2X. A fifth-generation (5G) new radio (NR) system, which is based on 5G technologies, may utilize sidelinks for multi-carrier communication in V2X, and the duplication communication is also required to improve a reliability of data communication.

### SUMMARY

A data communication method, a first device, and a second device are provided according to embodiments of the application, to realize data communication in a sidelink duplication transmission mode.

A data communication method is provided according to embodiments of the application, which is applicable to a first device and includes: transmitting, by the first device, first data on a sidelink in a duplication transmission mode.

A data communication method is provided according to embodiments of the application, which is applicable to a second device and includes: performing, by the second device, carrier sensing on a sidelink; and receiving, by the second device, first data transmitted on a current carrier; the first data being data transmitted by the first device in a duplication transmission mode.

A first device is provided according to embodiments of the application, which includes: a first processing unit configured to transmit first data on a sidelink in a duplication transmission mode for the first device.

A second device is provided according to embodiments of the application, which includes: a thirteenth processing unit configured to perform carrier sensing on a sidelink for the second device; and a fourteenth processing unit configured to receive first data transmitted on a current carrier; the first data being data transmitted by the first device in a duplication transmission mode.

A first device is provided according to embodiments of the application, which includes: a processor and a memory. The memory is configured to store a computer program, and the processor is configured to call and execute the computer program stored in the memory, thereby causing the first device to perform the method described according to the above-mentioned embodiments of the application.

A second device is provided according to embodiments of the application, which includes: a processor and a memory. The memory is configured to store a computer program, and the processor is configured to call and execute the computer program stored in the memory, thereby causing the second device to perform the method described according to the above-mentioned embodiments of the application.

A chip is provided according to embodiments of the application, for implementing the method described according to the above-mentioned embodiments of the application.

In detail, the chip includes a processor configured to call a computer program from a memory and execute the computer program, thereby causing a device equipped with the chip to perform the method described according to the above-mentioned embodiments of the application.

A computer-readable storage medium is provided according to embodiments of the application. The computer-readable storage medium stores a computer program. When the computer program is executed by a device, the device is caused to perform the method described according to the above-mentioned embodiments of the application.

A computer program product is provided according to embodiments of the application. The computer program product includes computer program instructions for causing a computer to perform the method described according to the above-mentioned embodiments of the application.

A computer program is provided according to embodiments of the application. When the computer program is executed on a computer, the computer is caused to perform the method described according to the above-mentioned embodiments of the application.

### BRIEF DESCRIPTION OF DRAWINGS

FIG. 1 is a schematic diagram of an application scenario according to embodiments of the application.

FIG. 2 is a schematic diagram of sidelink communication mode A according to embodiments of the application.

FIG. 3 is a schematic diagram of sidelink communication mode B according to embodiments of the application.

FIG. 4 is a schematic block diagram of duplication communication in a carrier aggregation (CA) scenario according to embodiments of the application.

FIG. 5 is a schematic diagram of another application scenario according to embodiments of the application.

FIG. 6 is a schematic flowchart of a data communication method according to embodiments of the application.

FIG. 7 is a schematic flowchart of a data communication method according to embodiments of the application.

FIG. 8 is a schematic flowchart of a data communication method according to embodiments of the application.

FIG. 9 is a schematic flowchart of a data communication method according to embodiments of the application.

FIG. 10 is a schematic flowchart of a data communication method according to embodiments of the application.

FIG. 11 is a schematic flowchart of a data communication method according to embodiments of the application.

FIG. 12 is a schematic flowchart of a data communication method according to embodiments of the application.

FIG. 13 is a schematic flowchart of application example 1 of a data communication method according to embodiments of the application.

FIG. 14 is a schematic flowchart of application example 2 of a data communication method according to embodiments of the application.

FIGS. 15a-15b are schematic flow charts of application example 3 of a data communication method according to embodiments of the application.

FIGS. 16a-16b are schematic flow charts of application example 4 of a data communication method according to embodiments of the application.

FIG. 17 is a schematic block diagram of a first device according to embodiments of the application.

FIG. 18 is a schematic block diagram of a second device according to embodiments of the application.

FIG. 19 is a schematic block diagram of a communication device according to embodiments of the application.

FIG. 20 is a schematic block diagram of a chip according to embodiments of the application.

FIG. 21 is a schematic block diagram of a communication system according to embodiments of the application.

### DETAILED DESCRIPTION

Technical solutions according to embodiments of the application will be described below with reference to accompanying drawings according to embodiments of the application.

The technical solutions according to embodiments of the application may be applicable to various communication systems, such as: global system of mobile communication (GSM), code division multiple access (CDMA) system, wideband code division multiple access (WCDMA) system, general packet radio service (GPRS), long term evolution (LTE) system, advanced LTE (LTE-A) system, a new radio (NR) system, an evolved system for the NR system, long term evolution-based access to unlicensed spectrum (LTE-U) system, new radio-based access to unlicensed spectrum (NR-U) system, non-terrestrial networks (NTN), universal mobile telecommunication system (UMTS), wireless local area networks (WLAN), wireless fidelity (Wi-Fi™), 5th-generation (5G) system, or other communication systems.

Conventional communication systems typically support a limited number of connections and are relatively easy to implement. However, with the development of communication technologies, mobile communication systems will not only support conventional communication, but will also support, for example, device to device (D2D) communication, machine to machine (M2M) communication, machine type communication (MTC), vehicle to vehicle (V2V) communication, or vehicle to everything (V2X) communication. The technical solutions according to embodiments of the application may also be applicable to these communication systems.

Alternatively, the communication systems according to embodiments of the application may be applicable to carrier aggregation (CA) scenarios, dual connectivity (DC) scenarios, or standalone (SA) deployment scenarios.

Alternatively, the communication systems according to embodiments of the application may be applicable to unlicensed spectrum, and the unlicensed spectrum may also be considered shared spectrum; or the communication systems according to embodiments of the application may be applicable to licensed spectrum, and the licensed spectrum may also be considered non-shared spectrum.

Various embodiments may be described in the application in conjunction with a network device and a terminal device. The terminal device may also be referred to as a user equipment (UE), an access terminal, a user unit, a user station, a mobile station, a mobile terminal, a remote station, a remote terminal, a mobile device, a user terminal, a terminal, a wireless communication device, a user agent, a user device, or similar devices.

The terminal device may be a station (STA) in WLAN, a cellular phone, a cordless phone, a session initiation protocol (SIP) phone, a wireless local loop (WLL) station, a personal digital assistant (PDA) device, a handheld device or computing device with wireless communication capabilities, other processing devices connected to a wireless modem, a vehicle-mounted device, a wearable device, a terminal device in a next-generation communication system such as NR network, a terminal device in future evolved public land mobile networks (PLMN), or similar devices.

According to embodiments of the application, the terminal device may be deployed on land, including indoor or outdoor, handheld, wearable, or vehicle-mounted; it may also be deployed on water (such as on ships); and it may also be deployed in the air (such as on aircrafts, balloons, or satellites).

According to embodiments of the application, the terminal device may be a mobile phone, a tablet computer, a computer with wireless transceiver functionality, a virtual reality (VR) terminal device, an augmented reality (AR) terminal device, a wireless terminal device in industrial control, a wireless terminal device in self-driving, a wireless terminal device in remote medical, a wireless terminal device in smart grids, a wireless terminal device in transportation safety, a wireless terminal device in smart cities, a wireless terminal device in smart homes, or the like.

As a non-limiting example, according to embodiments of the application, the terminal device may also be a wearable device. The wearable device may also be called a wearable smart device. The wearable device is a general term for devices that are designed intelligently and developed using wearable technologies for daily wear, such as glasses, gloves, watches, clothing, or shoes. The wearable device is a portable device that is worn directly on the body or integrated into the user's clothing or accessories. The wearable device is not just a hardware device; and it may also realize powerful functions through software support, data interaction, or cloud interaction. In a broad sense, the wearable smart device may include those that are fully functional, large in size, and capable of achieving complete or partial functions without relying on smartphones, such as smart watches or smart glasses, as well as those that focus on a specific application function and need to be used in conjunction with other devices such as smartphones, such as various smart bracelets and smart jewelry for vital sign monitoring.

According to embodiments of the application, the network device may be a device for communicating with the mobile device. The network device may be an access point (AP) in WLAN, a base transceiver station (BTS) in GSM or CDMA, a NodeB (NB) in WCDMA, an evolutional node B (eNB or eNodeB) in LTE, a relay station or access point, a vehicle-mounted device, a wearable device, a network device (gNB) in NR, a network device in the future evolved PLMN, a network device in the NTN, etc.

As a non-limiting example, according to embodiments of the application, the network device may have mobile characteristics, for example, the network device may be a device that may move. Alternatively, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Alternatively, the network device may also be a base station arranged on land, water or the like.

According to embodiments of the application, the network device may provide services for a cell, and the terminal device may communicate with the network device through communication resources (e.g., frequency domain resources or spectrum resources) used by the cell. The cell may correspond to the network device (e.g., the base station). The cell may belong to a macro base station or a base station corresponding to a small cell. The small cell herein may include a metro cell, a micro cell, a pico cell, a femto cell, or the like. These small cells have the characteristics of small coverage and low communication power, and are suitable for providing high-speed data communication services.

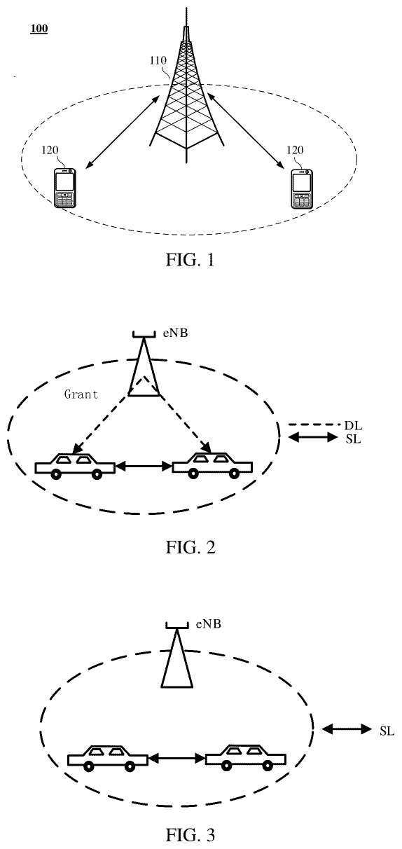

FIG. 1 illustrates a communication system 100 as an example. The communication system 100 may include a network device 110 and two terminal devices 120. Alternatively, the communication system 100 may include a plurality of network devices 110. Each network device 110 may cover any number of terminal devices 120 within its coverage area, which is not limited according to embodiments of the application.

Alternatively, the communication system 100 may also include other network entities such as a mobility management entity (MME) and an access and mobility management function (AMF), which is not limited according to embodiments of the application.

The network device may include an access network device and a core network device. That is, the wireless communication system also may include a plurality of core networks for communicating with access network devices. The access network device may be an evolutional base station (which may be abbreviated as eNB or e-NodeB) in the LTE system, the NR system, or an authorized auxiliary access long-term evolution (LAA-LTE) system, a macro base station, a micro base station (also called a “small base station”), a pico base station, an AP, a communication point (TP), a new generation Node B (gNodeB), etc.

It should be understood that a device having a communication function in a network/system according to embodiments of the application may be referred to as a communication device. Taking the communication system illustrated in FIG. 1 as an example, the communication device may include the network device with communication functions and the terminal device with communication functions. The network device and the terminal device may be specific devices according to embodiments of the application and will not be repeated herein. The communication device may also include other devices in the communication system, such as network controllers, mobile management entities, or other network entities, which are not limited to embodiments of the application.

It should be understood that the terms “system” and “network” in this specification are often used interchangeably herein. The term “and/or” in this specification may describe association relationships of associated objects, indicating that there may be three types of relationships, for example, A and/or B, which may mean: A exists alone, A and B exist at the same time, and B exists alone. The character “/” in this specification generally indicates that the associated objects before and after are in an “or” relationship.

It should be understood that the term “indication” or its variant mentioned according to embodiments of the application may be a direct indication, an indirect indication, or represent an association relationship. For example, A indicates B, which may mean that A directly indicates B, such as B may be obtained through A, or mean that A indirectly indicates B, such as A indicates C and B may be obtained through C, or mean that there is an association relationship between A and B.

In the description according to embodiments of the application, the term “corresponding” or its variant may denote a direct or indirect correspondence between two items, or an association relationship between the two items, or a relationship involving indication and being indicated, configuration and being configured, or the like.

To facilitate understanding of the technical solutions according to embodiments of the application, the related technologies according to embodiments of the application will be described below. The following related technologies may be arbitrarily combined with the technical solutions according to embodiments of the application as alternative solutions, and they all fall within the scope according to the embodiments of the application.

For LTE D2D/V2X, D2D or V2X technologies may involve sidelink (SL) communication technologies based on D2D. Unlike conventional cellular systems where communication data are received or transmitted through the base station, D2D/V2X may offer higher spectrum efficiency and reduced communication latency. D2D/V2X is typically used in a vehicle-to-everything (V2X) system. In the V2X system, D2D/V2X enables direct communication between terminal devices. The 3rd generation partnership project (3GPP) defines the following two communication modes for D2D/V2X: mode A and mode B.

For mode A, as illustrated in FIG. 2, communication resource(s) may be allocated by the network device (such as the base station) for the terminal device (such as the vehicle-mounted terminal), and the terminal device may transmit data on the sidelink according to the resource(s) allocated by the base station. The base station may either allocate resource(s) for an individual communication session to the terminal device or allocate resource(s) for semi-static communication to the terminal device.

For mode B, as illustrated in FIG. 3, the terminal device (such as the vehicle-mounted terminal) may select a resource from a resource pool for data communication.

In 3GPP, D2D may include the following different research stages.

Stage 1: regarding proximity based service (ProSe), the D2D communication studied in Rel-12/13 was focused on ProSe scenarios, which primarily targeted public safety services. In ProSe, by configuring positions of the resource pool in the time domain, for example, making the resource pool discontinuous in the time domain, the terminal device may transmit/receive data discontinuously on the sidelink, thereby achieving power savings.

Stage 2: regarding V2X, in Rel-14/15, vehicle-to-vehicle communication scenarios for the V2X system were studied, which primarily targeted relatively high-speed vehicle-to-vehicle and vehicle-to-person communication services. In V2X, since a vehicle-mounted system has a continuous power supply, power efficiency is not the primary issue, instead, the delay of data communication is the primary issue. Therefore, the system design requires the terminal device to perform continuous communication and reception.

Stage 3: regarding wearable devices (FeD2D), in Rel-14, scenarios where wearable devices access the network through mobile phones were studied, primarily focusing on scenarios of low mobility speed and low power access. In FeD2D, the base station may configure discontinuous reception (DRX) parameters of the remote terminal through the terminal device acting as a relay node.

NR V2X was proposed based on LTE V2X. NR V2X is not limited to broadcast scenarios but is further expanded to unicast and multicast scenarios. V2X applications may be studied in the following scenarios.

Scenario 1: NR V2X defines two resource grant modes, mode 1 and mode 2. Furthermore, users may operate in a mixed mode, meaning they may use both mode 1 and mode 2 simultaneously to obtain resources. The resource obtaining is indicated by a sidelink grant, that is, the sidelink grant indicates a corresponding time-frequency resource position of a physical sidelink control channel (PSCCH) and a physical sidelink shared channel (PSSCH).

Scenario 2: in addition to a hybrid automatic repeat request (HARQ) initiated autonomously by the terminal device without feedback, NR V2X introduces feedback-based HARQ recommunication, which is not limited to unicast communication but also may include multicast communication.

Regarding LTE-V2X carrier aggregation, carrier selection in LTE-V2X carrier aggregation may be accomplished by the following mechanisms:

An upper layer may configure a mapping relationship between service types and carriers, meaning that for a certain service, the upper layer indicates a set of available carriers to an access layer (AS).

Furthermore, the AS layer may configure a set of available carriers for each logical channel and a constant bit rate (CBR) measurement threshold which is configured for data priority in each resource pool. The UE may measure the CBR in the resource pool and compares it with the CBR threshold corresponding to the priority of the transmitted data. If the measured value is lower than the threshold, the carrier is considered to be available.

Regarding NR Uu carrier aggregation, carrier aggregation is a bandwidth extension technology introduced in the LTE-Advanced standard. It allows the aggregation of multiple component carriers (CCs) to be received or transmitted simultaneously by one UE. Depending on the scope of the aggregated carriers, carrier aggregation may be divided into intra-band carrier aggregation (intra-band CA) and inter-band carrier aggregation (inter-band CA). One of the main uses of intra-band carrier aggregation is for scenarios where the cell carrier bandwidth is greater than the single carrier bandwidth capability of the terminal device. In this case, the terminal device may use carrier aggregation to operate in a “wide carrier”. For example, if the base station supports one carrier of 300 MHz, while the terminal device only supports a carrier of up to 100 MHz, the terminal device may use carrier aggregation to achieve broadband operation greater than 100 MHz. The aggregated carriers may be adjacent or non-adjacent.

When the terminal device and the network device communicate through carrier aggregation, a primary cell (PCell) and a secondary cell (PSCell) may be configured at the same time. Abeam failure recovery mechanism is designed for the primary cell and the secondary cell. Its main functional modules (or main steps) are divided into the following four parts:
beam failure detection (BFD)
new beam identification (NBI)
beam failure recovery request (BFRQ)
network side response.

The terminal device may measure a physical downlink control channel (PDCCH) to determine a link quality corresponding to a downlink transmit beam. If the link quality is very poor, it is considered that a beam failure has occurred on the downlink beam. The terminal device may also measure a set of candidate beams to select a beam that satisfies a certain threshold as a new beam. The terminal device may notify the network device of the beam failure and report a new beam through a BFRQ process. Upon receiving the BFRQ information transmitted by the terminal device, the network device may recognize that the terminal device has experienced a beam failure and choose to transmit the PDCCH on the new beam. When the terminal device receives the PDCCH transmitted by the network on the new beam, it may consider that the response information from the network device side has been correctly received. At this point, the beam failure recovery process is successfully completed.

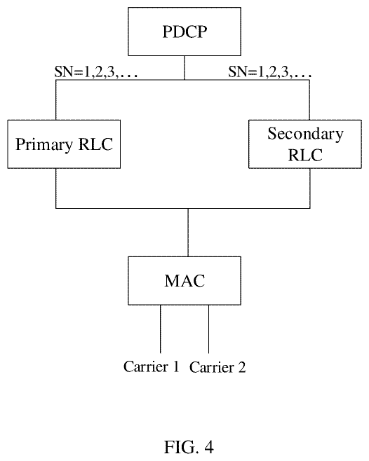

Regarding packet data convergence protocol (PDCP) duplication communication, in the carrier aggregation scenario, after the PDCP duplication communication is enabled, data packets, on signaling radio bearer (SRB)/data radio bearer (DRB) of the communication terminal, may be transmitted on logical channels corresponding to two radio link control (RLC) entities (one of the RLC entities is the primary RLC entity (primary RLC) and the other is the secondary RLC entity (secondary RLC) configured for this SRB/DRB (if the two RLC entities serve the same radio bearer, the srb-Identity or drb-Identity in their corresponding configuration RLC-BearerConfig will be set to the same value). Finally, a media access control (MAC) layer maps them to communication resources corresponding to different carriers when forming the MAC PDU (such as mapping to communication resources corresponding to different carriers through a logical channel selection process of an uplink grant). The specific architecture is illustrated in FIG. 4. As illustrated in FIG. 4, the network device may first configure the RLC communication link related to each DRB for the terminal device through the radio resource control (RRC) signaling (i.e., setting the DRB IDs corresponding to more than two RLC entities or the SRB IDs corresponding to more than two RLC entities to the same value). Furthermore, duplication communication may be activated/deactivated for the relevant RLC entities through an RRC and a medium access control control element (MAC CE).

In conclusion, the duplication communication in LTE V2X only supports priority-based judgment and the mapping relationship between the original logical channel and the duplicated logical channel being fixed, as illustrated in Table 1. This fixed configuration does not consider different states of the terminal device. However, actual data communication scenarios include unicast, multicast, broadcast, the terminal device operating under different network coverages, and the like. The introduction of unicast and multicast also provides the possibility for more flexible configuration manners. The current duplication transmission mode may not satisfy requirements of various data communication scenarios in NR-V2X, especially when utilizing sidelinks for multi-carrier communications.

TABLE 1

| | Idle state/Inactive state/ | |
|---|---|---|
| | Out of context | |
| | (OOC) state | CONNECTED state |
| group | No dedicated | No dedicated |
| communication/ | NW control; | NW control; |
| broadcast (GC/BC) | No PC5-RRC | No PC5-RRC |
| unicast (UC) | No dedicated | No dedicated |
| | NW control; | NW control; |
| | No PC5-RRC | No PC5-RRC |

The following embodiments of the application may use multi-carrier communication via sidelink in NR-V2X as an example, focusing on different coverage conditions and RRC states of the terminal device, combining various data communication scenarios including unicast, multicast, and broadcast, to explain how the sidelink may support the duplication transmission mode to improve the reliability of data communication.

It should be noted that the first device may be a transmitting UE and the second device may be a receiving UE; alternatively, the first device may be a receiving UE and the second device may be a transmitting UE. The second device may be the terminal device (such as the receiving UE or the transmitting UE). Depending on different networking architectures, the second device may also be the network device. When the second device is the terminal device, regardless of whether the first device or the second device serves as the transmitting UE or the receiving UE, both devices need to support/enable the duplication transmission mode. Regardless of whether either the first device or the second device serves as the transmitting UE or the receiving UE, the following operation may be performed: activating the duplication transmission mode, and transmitting the first data on the sidelink in the duplication transmission mode after activating the duplication transmission mode. Herein, “enable” means that, for the duplication transmission mode, it is not a certain capability supported by the first device, but rather the first device is configured to support the communication of the first data in the duplication transmission mode on its carrier or logical channel.

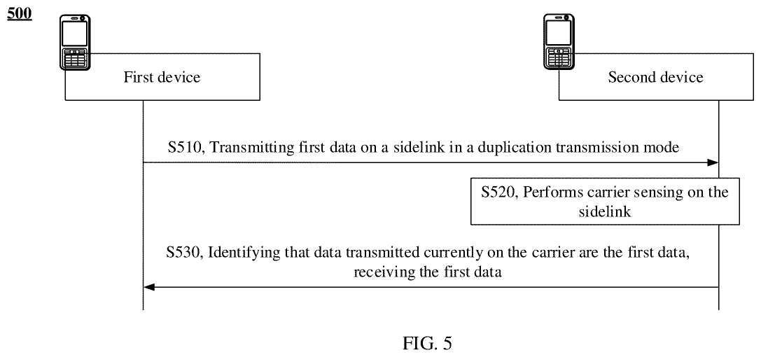

FIG. 5 is a schematic diagram of another application scenario according to embodiments of the application, which illustrates an interaction process of a data communication method according to embodiments of the application as an example. Taking the first device and the second device as terminal devices (such as mobile phones) as an example, the interaction process may include some or all of the following steps:

S510, the first device transmits first data on a sidelink in a duplication transmission mode.

S520, the second device performs carrier sensing on the sidelink.

S530, the second device receives the first data transmitted on a current carrier.

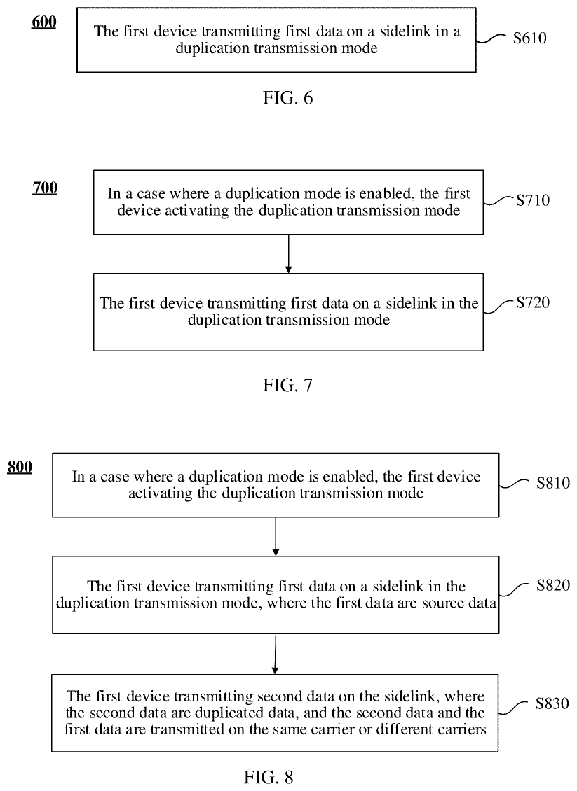

FIG. 6 is a schematic flowchart of a data communication method 600 according to embodiments of the application. Alternatively, the method may be applicable to the system illustrated in FIG. 1, but is not limited thereto. The method may include at least part of the following:

S610, the first device transmits first data on a sidelink in a duplication transmission mode.

In some examples, the first device may be the transmitting ULE and the second device may be the receiving UE.

By adopting embodiments of the application, the first device may realize data communication in the sidelink duplication transmission mode by transmitting the first data on the sidelink in the duplication transmission mode.

In a possible implementation, the method further may include: determining, by the first device, whether the duplication transmission mode is enabled or disabled according to a first rule. The first rule (such as a defined mapping relationship or a defined rule, which may also refer to as a first condition such as a defined mapping relationship or a defined condition) may be obtained through at least one of: a pre-configuration, an indication of a system message, or an indication of an upper layer.

In some examples, the first rule may be associated with at least one configuration manner. That is, the definition of the first rule may be associated with a multi-granularity configuration manner. For example, the multi-granularity configuration manner may include at least one of the following division granularities: each service type, a quality of service (QoS) flow, a data link layer 2 (L2) identifier, a logical channel, a transport (Tx) protocol, a data communication type, a data communication priority, a carrier, a resource pool, or a CBR level. Thus, by adopting embodiments of the application, the data communication in the sidelink duplication transmission mode may be realized, and the multi-granularity configuration manner may satisfy requirements of various data communication scenarios.

The embodiments of the application provide a data communication method, applicable to a first device, which includes:
transmitting, by the first device, first data on a sidelink in a duplication transmission mode.

In some embodiments, the method further includes:
determining, by the first device, whether the duplication transmission mode is enabled or disabled according to a first rule,
where the first rule is obtained through at least one of: a pre-configuration, an indication of a system message, or an indication of an upper layer.

In some embodiments, the first rule is related to at least one of: a service type, a quality of service (QoS) flow, a data link layer 2 (L2) identifier, a logical channel, a transport (Tx) protocol, a data communication type, a data communication priority, a carrier, a resource pool, or a constant bit rate (CBR) level.

In some embodiments, the method further includes:
activating, by the first device, the duplication transmission mode in a case where the duplication transmission mode is enabled.

In some embodiments, the activating, by the first device, the duplication transmission mode includes:
activating the duplication transmission mode in a case where a first condition is satisfied.

In some embodiments, the first condition includes at least one of:
a data communication priority being greater than a priority requirement;
a CBR measurement value of a resource pool being less than a first threshold;
a sidelink reference signal receiving power (SL-RSRP) measurement value being greater than a second threshold and/or less than a third threshold;
receiving an indication of an upper layer, the indication of the upper layer for activating the duplication transmission mode;
failure to receive feedback on a physical sidelink feedback channel (PSFCH) for N consecutive times, where N is a positive integer greater than 1;
failure to receive an acknowledgment (ACK) feedback for N consecutive times, where N is a positive integer greater than 1; or
receiving, from a second device, a first signaling, the first signaling for indicating to activate the duplication transmission mode.

In some embodiments, the transmitting, by the first device, first data on a sidelink in a duplication transmission mode, includes:
transmitting, by the first device, the first data and second data on the sidelink, the second data being duplicated data,
wherein the second data and the first data are transmitted on a same carrier or different carriers.

In some embodiments, the method further includes:
a correspondence between the second data and the first data being determined through at least one of: a carrier mapping indication, a logical channel identifier mapping indication, an explicit indication, a network configuration, or a pre-configuration.

In some embodiments, the method further includes:
receiving, by the first device, a second signaling initiated by the second device; and
configuring, by the first device in response to the second signaling, the first data to be transmitting on the sidelink in the duplication transmission mode.

In some embodiments, the second signaling includes at least one of a radio resource control (RRC) signaling, a medium access control control element (MAC CE), or a physical layer signaling.

In some embodiments, in a case where the second signaling carries the RRC signaling, the method further includes:
obtaining the first rule through an indication of the RRC signaling.

In some embodiments, the receiving, from a second device, a first signaling, includes at least one of:
receiving, from the second device, the first signaling in a case where an RSRP measurement value of the second device is greater than the second threshold and/or less than the third threshold; or
receiving, from the second device, the first signaling in a case where the second device fails to receive data for N consecutive times.

In some embodiments, the method further includes:
exchanging capability information between the first device and a second device; and
determining, by the first device, whether the duplication transmission mode is enabled or disabled according to the first rule and/or the capability information.

In some embodiments, the capability information includes at least one of: information that the first device and/or the second device has enabled the duplication transmission mode, information that the first device and/or the second device is about to enter the duplication transmission mode, or information that the first device and/or the second device requests duplication resources.

In some embodiments, the second device includes a terminal device or a network device.

The embodiments of the application further provide a data communication method, applicable to a second device, which includes:
performing, by the second device, carrier sensing on a sidelink; and
receiving, by the second device, first data transmitted on a current carrier,
the first data being data transmitted by a first device in a duplication transmission mode.

In some embodiments, the performing, by the second device, carrier sensing on a sidelink, includes:
performing, by the second device, the carrier sensing according to a carrier selection and/or a carrier configuration.

In some embodiments, the method further includes:
identifying, by the second device, the first data transmitted on the current carrier according to a first rule, wherein the first rule is obtained through at least one of: a pre-configuration, an indication of a system message, an indication of an RRC signaling, or an indication of an upper layer.

In some embodiments, the first rule is related to at least one of: a service type, a QoS flow, a L2 identifier, a logical channel, a Tx protocol, a data communication type, a data communication priority, a carrier, a resource pool, or a CBR level.

In some embodiments, the method further includes:
transmitting, by the second device, a first signaling to the first device, the first signaling for indicating to activate the duplication transmission mode.

In some embodiments, the first signaling is transmitted in a case where an RSRP measurement value of the second device is greater than a second threshold and/or less than a third threshold.

In some embodiments, the first signaling is transmitted when/after the second device fails to receive data for N consecutive times.

In some embodiments, the method further includes:
transmitting, by the second device, a second signaling, the second signaling for configuring the duplication transmission mode.

In some embodiments, the second signaling includes at least one of: an RRC signaling, an MAC CE, or a physical layer signaling.

In some embodiments, the method further includes:
exchanging capability information between the second device and the first device; and
determining, by the second device, whether the duplication transmission mode is enabled or disabled according to the first rule and/or the capability information.

In some embodiments, the capability information includes at least one of: information that the first device and/or the second device has enabled the duplication transmission mode, information that the first device and/or the second device is about to enter the duplication transmission mode, or information that the first device and/or the second device requests duplication resources.

FIG. 7 is a schematic flowchart of a data communication method 700 according to embodiments of the application. Alternatively, the method may be applicable to the system illustrated in FIG. 1, but is not limited thereto. The method may include at least part of the following:

S710, in a case where a duplication transmission mode is enabled, the first device activates the duplication transmission mode.

S720, the first device transmits first data on a sidelink in the duplication transmission mode.

In some examples, the first device may be the transmitting UE and the second device may be the receiving UE.

In some examples, with respect to activating the duplication transmission mode, the duplication transmission mode may be activated in a case where a first condition is satisfied, thereby enabling the first data to be transmitted after the duplication transmission mode is activated.

In some examples, the first condition may include at least one of the following:
1) a data communication priority being greater than a priority requirement;
2) a CBR measurement value of a resource pool being less than a first threshold (such as a maximum threshold);
3) a sidelink reference signal receiving power (SL-RSRP) measurement value being greater than a second threshold (such as a minimum threshold) and/or less than a third threshold (such as a maximum threshold);
4) receiving an indication of an upper layer, the indication of the upper layer for activating the duplication transmission mode;
5) failure to receive feedback on a physical sidelink feedback channel (PSFCH) for N consecutive times, where N is a positive integer greater than 1;
6) failure to receive an acknowledgment (ACK) feedback for N consecutive times, where N is a positive integer greater than 1; or
7) receiving, from a second device, a first signaling, the first signaling for indicating to activate the duplication transmission mode. For example, the first signaling may be a signaling for indicating the activation of the duplication transmission mode (duplication activation).

There is no necessary sequential relationship between steps S710-S720, and some steps may be performed as needed. It is not necessary to perform these steps in sequence.

FIG. 8 is a schematic flowchart of a data communication method 800 according to embodiments of the application. Alternatively, the method may be applicable to the system illustrated in FIG. 1, but is not limited thereto. The method may include at least part of the following:

S810, in a case where a duplication transmission mode is enabled, the first device activates the duplication transmission mode.

S820, the first device transmits first data on a sidelink in the duplication transmission mode, where the first data are source data.

S830, the first device transmits second data on the sidelink, where the second data are duplicated data, and the second data and the first data are transmitted on the same carrier or different carriers.

In some examples, the first device may be the transmitting UE and the second device may be the receiving UE.

In some examples, with respect to activating the duplication transmission mode, the duplication transmission mode may be activated in a case where a first condition is satisfied, thereby enabling the first data to be transmitted after the duplication transmission mode is activated.

In some examples, the first condition may include at least one of the following:
1) a data communication priority being greater than a priority requirement;
2) a CBR measurement value of a resource pool being less than a first threshold (such as a maximum threshold);
3) an SL-RSRP measurement value being greater than a second threshold (such as a minimum threshold) and/or less than a third threshold (such as a maximum threshold);
4) receiving an indication of an upper layer, the indication of the upper layer for activating the duplication transmission mode;
5) failure to receive feedback on a PSFCH for N consecutive times, where N is a positive integer greater than 1;
6) failure to receive an ACK feedback for N consecutive times, where N is a positive integer greater than 1; or
7) receiving, from a second device, a first signaling, the first signaling for indicating to activate the duplication transmission mode. For example, the first signaling may be a signaling for indicating the activation of the duplication transmission mode (duplication activation). For example, the second device may include the terminal device or the network device, where the terminal device may be the transmitting UE or the receiving UE.

In some examples, a correspondence between the second data and the first data (such as the duplication relationship between the second data and the first data) is determined through at least one of: a carrier mapping indication, a logical channel identifier mapping indication, an explicit indication, a network configuration, or a pre-configuration. In detail, it may include the following content:
1) the carrier mapping indication may be used between the second data and the first data to determine the corresponding duplication relationship between the second data and the first data;
2) the logical channel identifier mapping indication may be used between the second data and the first data to determine the corresponding duplication relationship between the second data and the first data;
3) the explicit indication may be used between the second data and the first data to determine the corresponding duplication relationship between the second data and the first data.

There is no necessary sequential relationship among steps S810-S830, and some steps may be performed as needed. It is not necessary to perform these steps in sequence.

In a possible implementation, the method further may include: receiving, by the first device, a second signaling initiated by a first network device; and configuring, by the first device in response to the second signaling, the first data to be transmitted on the sidelink in the duplication transmission mode.

In some examples, the second signaling may be a configuration signaling of the duplication transmission mode (duplicated config). The second signaling may include at least one of: an RRC signaling, an MAC CE, or a physical layer signaling.

In some examples, in a case where the second signaling carries the above-mentioned RRC signaling, the method also may include: obtaining the above-mentioned first rule through an indication of the RRC signaling.

In a possible implementation, receiving the first signaling from the second device may include at least one of the following:
1) in a case where an RSRP measurement value of the second device is greater than the second threshold and/or less than the third threshold, receiving the first signaling transmitted by the second device; or
2) in a case where the second device fails to receive data for N consecutive times, receiving the first signaling transmitted by the second device.

In a possible implementation, the method further may include: exchanging capability information between the first device and the second device, and determining, by the first device, whether the duplication transmission mode is enabled or disabled according to the first rule and/or the capability information.

In some examples, the capability information may include at least one of: information that the first device and/or the second device has enabled the duplication transmission mode, information that the first device and/or the second device is about to enter the duplication transmission mode, or information that the first device and/or the second device requests duplication resources.

In some examples, in addition to the interaction between two terminal devices (such as the first device and the second device), the network device (such as the first network device) may also be introduced into the networking architecture for the interaction between the two terminal devices. In detail, the first network device may transmit the second signaling (such as the RRC signaling) to the first device for configuration, and request the first device to perform various processing such as duplication (such as transmitting the first data in the duplication transmission mode), and the first network device may also receive the request response from the first device.

In some examples, the second signaling (such as the indication of the first network device through the RRC signaling) may be a configuration signaling for the duplication transmission mode; the third signaling may be a request signaling for activating the duplication transmission mode; and the fourth signaling may be a request response signaling for activating the duplication transmission mode.

In a possible implementation, the method may also include: receiving, by the first device, the third signaling initiated by the first network device, where the third signaling is configured to carry an indication of activating the duplication transmission mode; triggering, by the first device in response to the third signaling, the duplication transmission mode to enter an activated state according to the indication of activating the duplication transmission mode; and transmitting, by the first device, the fourth signaling to the first network device, where the fourth signaling is configured to notify the first network device of the duplication condition of the first device.

In some examples, the third signaling may include: the RRC signaling, the MAC CE signaling, or the physical layer signaling (such as PDCCH).

In some examples, in a case where the second signaling carries an indication of the RRC signaling, the method may also include: obtaining the above-mentioned first rule through the indication of the RRC signaling.

In some examples, in addition to the interaction between two terminal devices (such as the first device and the second device), after the network device (such as the first network device) is introduced, the method may further include: activating the duplication transmission mode in a case where the first device satisfies the following first condition.

The first condition may include: receiving a first signaling, where the first signaling is configured to indicate the activation of the duplication transmission mode. The second device transmits the first signaling based on one of the following conditions:
1) the RSRP measurement value being greater than the second threshold (such as the minimum threshold) and/or less than the third threshold (such as the maximum threshold);
2) the first signaling for indicating that the second device has failed to receive data for N consecutive times;
3) the first signaling for indicating that the second device has received an instruction initiated by a second network device to activate the duplication transmission mode.

In a possible implementation, the method may also include: receiving, by the first device, a tenth signaling transmitted by the second device, where the tenth signaling is configured to configure the duplication transmission mode, and configuring, by the first device in response to the tenth signaling, to transmit the first data on the sidelink in the duplication transmission mode.

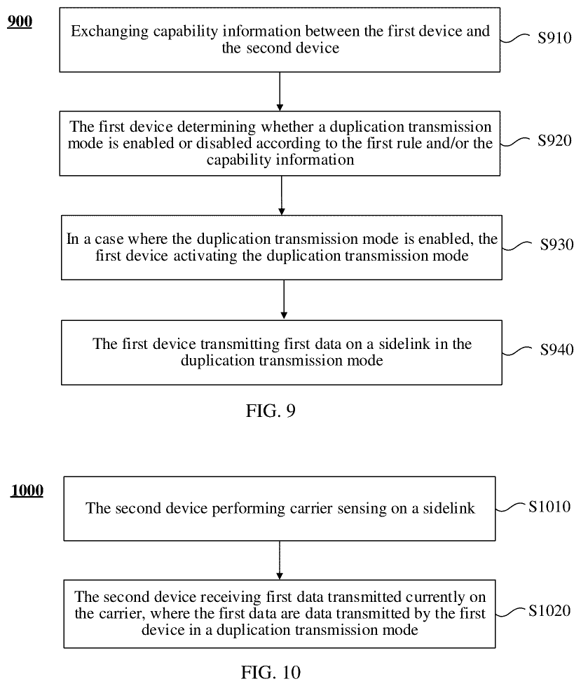

FIG. 9 is a schematic flowchart of a data communication method 900 according to embodiments of the application. Alternatively, the method may be applicable to the system illustrated in FIG. 1, but is not limited thereto. The method may include at least part of the following:

S910, capability information is exchanged between the first device and the second device.

S920, the first device determines whether a duplication transmission mode is enabled or disabled according to the first rule and/or the capability information.

S930, in a case where the duplication transmission mode is enabled, the first device activates the duplication transmission mode.

S940, the first device transmits first data on a sidelink in the duplication transmission mode.

In some examples, in addition to determining whether the duplication transmission mode is enabled or disabled according to the first rule in the above embodiments, the support for signaling interaction/configuration (such as capability interaction) between the first device and the second device may be further introduced.

In some examples, the first device may be the transmitting UE and the second device may be the receiving UE.

In some examples, the capability information may include at least one of: information that the first device and/or the second device has enabled the duplication transmission mode, information that the first device and/or the second device is about to enter the duplication transmission mode, or information that the first device and/or the second device requests duplication resources.

There is no necessary sequential relationship among steps S910-S940, and some steps may be performed as needed. It is not necessary to perform these steps in sequence.

In a possible implementation, the method also may include: transmitting, by the first device, a fifth signaling to the first network device after exchanging capability information; receiving, by the first device, a sixth signaling initiated by the first network device, and configuring, by the first device in response to the sixth signaling, to transmit the first data on the sidelink in the duplication transmission mode.

In some examples, with respect to the fifth signaling, the first device may report the fifth signaling to the network device in a connected state and/or in mode 1 resource selection and/or when the network supports sidelink duplication.

In some examples, in addition to the interaction between two terminal devices (such as the first device and the second device), the network device (such as the first network device) may also be introduced. In detail, the first device may transmit the fifth signaling (such as the RRC signaling) after the interaction of the capability information, and request the first network device to configure the first device so that the first device may perform various processing such as duplication (such as transmitting the first data in the duplication transmission mode).

In some examples, the fifth signaling (such as the RRC message reported by the first device to the first network device) may include that the peer UE (such as the second device) of the first device supports and/or enables duplication communication, or is about to perform duplication communication, or request duplication communication resources; and the sixth signaling (such as the indication from the first network device through the RRC signaling) may be a configuration signaling for the duplication transmission mode.

In some examples, the capability information is carried in the fifth signaling; where the capability information may include at least one of: information that the first device and/or the second device has enabled the duplication transmission mode, information that the first device and/or the second device is about to enter the duplication transmission mode, or information that the first device and/or the second device requests duplication resources.

In some examples, in a case where the sixth signaling carries the indication of the RRC signaling, the method may also include: obtaining the first rule through the indication of the RRC signaling.

In some examples, in addition to the interaction between two terminal devices (such as the first device and the second device), after the network device (such as the first network device) is introduced, the method may further include: activating the duplication transmission mode in a case where the first device satisfies the following first condition.

The first condition may include: receiving a first signaling, where the first signaling is configured to indicate that after activating the duplication transmission mode, the RSRP measurement value of the second device is greater than the second threshold and/or less than the third threshold, or the first signaling is configured to indicate that the second device has failed to receive data for N consecutive times, or the first signaling is configured to indicate that the second device has received the indication of activating the duplication transmission mode, which is initiated by the second network device.

In some examples, the method may also include: receiving, by the first device, the seventh signaling initiated by the first network device, where the seventh signaling is configured to carry the indication of activating the duplication transmission mode; triggering, by the first device in response to the seventh signaling, the duplication transmission mode to enter an activated state according to the indication of activating the duplication transmission mode; and transmitting, by the first device, the eighth signaling to the first network device, where the eighth signaling is configured to notify the first network device of the duplication condition of the first device. The seventh signaling may be a request signaling for activating the duplication transmission mode; and the eighth signaling may be a request response signaling for activating the duplication transmission mode.

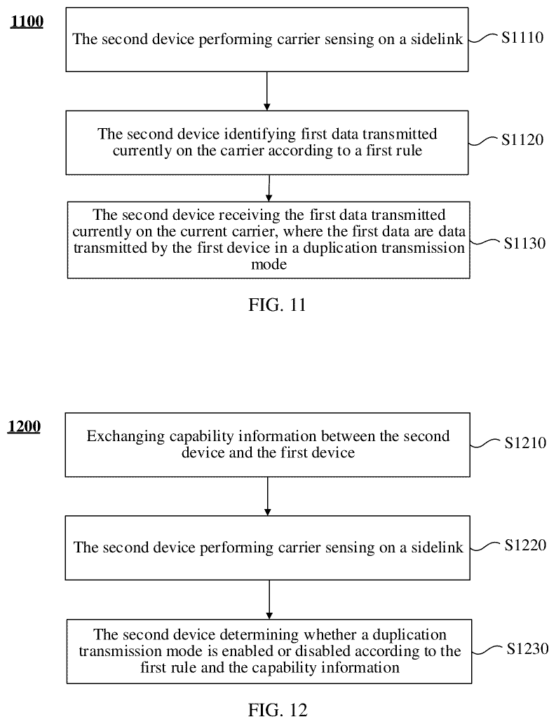

FIG. 10 is a schematic flowchart of a data communication method 1000 according to embodiments of the application. Alternatively, the method may be applicable to the system illustrated in FIG. 1, but is not limited thereto. The method may include at least part of the following:

S1010, the second device performs carrier sensing on a sidelink.

S1020, the second device receives first data transmitted on a current carrier, where the first data are data transmitted by the first device in a duplication transmission mode.

In some examples, the first device may be the transmitting UE and the second device may be the receiving UE.

In some examples, the second device may perform carrier sensing on the sidelink based on a carrier selection and/or a carrier configuration.

By adopting embodiments of the application, the first device may transmit the first data on the sidelink in the duplication transmission mode to realize data communication in the sidelink duplication transmission mode, and the second device may receive the first data transmitted on the current carrier through carrier sensing.

There is no necessary sequential relationship between steps S1010-S1020, and some steps may be performed as needed. It is not necessary to perform these steps in sequence.

FIG. 11 is a schematic flowchart of a data communication method 1100 according to embodiments of the application. Alternatively, the method may be applicable to the system illustrated in FIG. 1, but is not limited thereto. The method may include at least part of the following:

S1110, the second device performs carrier sensing on a sidelink.

S1120, the second device identifies first data transmitted on the current carrier according to a first rule.

S1130, the second device receives the first data transmitted on the current carrier, where the first data are data transmitted by the first device in a duplication transmission mode.

In some examples, the first device may be the transmitting UE and the second device may be the receiving UE.

In some examples, the second device may perform carrier sensing on the sidelink based on the carrier selection and/or the carrier configuration.

In some examples, the first rule may be obtained through at least one of: a pre-configuration, an indication of a system message, an indication of an RRC signaling, or an indication of an upper layer, so that the second data may be identified and received according to the first rule.

In some examples, the first rule may be associated with at least one configuration manner. That is, the definition of the first rule may be associated with a multi-granularity configuration manner. For example, the multi-granularity configuration manner may include at least one of the following division granularities: each service type, a QoS flow, a L2 identifier, a logical channel, a Tx protocol, a data communication type, a data communication priority, a carrier, a resource pool, or a CBR level. Thus, by adopting embodiments of the application, the data communication in the sidelink duplication transmission mode may be realized, and the multi-granularity configuration manner may satisfy requirements of various data communication scenarios.

There is no necessary sequential relationship between steps S1110-S1130, and some steps may be performed as needed. It is not necessary to perform these steps in sequence.

In a possible implementation, the method may further include: transmitting, by the second device, a first signaling, to the first device, where the first signaling is configured to indicate to activate the duplication transmission mode.

In some examples, the first signaling may be transmitted in a case where the RSRP measurement value of the second device is greater than the second threshold (such as the minimum threshold) and/or less than the third threshold (such as the maximum threshold).

In some examples, the first signaling may be transmitted when/after the second device fails to receive data for N consecutive times.

In a possible implementation, the method may also include: receiving, by the second device, a ninth signaling initiated by the second network device, where the ninth signaling is configured to configure the duplication transmission mode; and transmitting, by the second device in response to the ninth signaling, a tenth signaling to the first device, where the tenth signaling is configured to configure the duplication transmission mode.

In some examples, the ninth signaling (such as the indication from the second network device through the RRC signaling) may be a configuration signaling (duplicated config) of the duplication transmission mode; and the tenth signaling may be a configuration signaling (duplicated config) of the duplication transmission mode, transmitted by the first device to the second device.

FIG. 12 is a schematic flowchart of a data communication method 1200 according to embodiments of the application. Alternatively, the method may be applicable to the system illustrated in FIG. 1, but is not limited thereto. The method may include at least part of the following:

S1210, capability information between the second device and the first device is exchanged.

S1220, the second device performs carrier sensing on a sidelink.

S1230, the second device determines whether a duplication transmission mode is enabled or disabled according to the first rule and the capability information.

In some examples, the duplication transmission mode may be activated on the second device after the capability interaction. The capability information may include at least one of: information that the first device and/or the second device has enabled the duplication transmission mode, information that the first device and/or the second device is about to enter the duplication transmission mode, or information that the first device and/or the second device requests duplication resources.

In some examples, the first device may be the transmitting UE and the second device may be the receiving UE.

In some examples, based on the first rule and the capability information, the second device may identify the first data transmitted on the current carrier, and the second device may receive the first data transmitted on the current carrier, where the first data are data transmitted by the first device in the duplication transmission mode.

There is no necessary sequential relationship between steps S1210-S1230, and some steps may be performed as needed. It is not necessary to perform these steps in sequence.

In a possible implementation, the method may also include: transmitting, by the second device, an eleventh signaling to the first device, where the eleventh signaling is configured to indicate the activation of the duplication transmission mode; and/or transmitting, by the second device, a twelfth signaling to the first device, where the twelfth signaling is configured to configure the duplication transmission mode. For example, the eleventh signaling may be a signaling for indicating the activation of the duplication transmission mode (duplication activation); and the twelfth signaling may be a signaling for configuring the duplication transmission mode (duplication activation indication).

In a possible implementation, the method may also include: receiving, by the second device, a thirteenth signaling transmitted by the second network device, where the thirteenth signaling is configured to indicate the activation of the duplication transmission mode; and/or receiving, by the second device, a fourteenth signaling transmitted by the second network device, where the fourteenth signaling is configured to configure the duplication transmission mode. For example, the thirteenth signaling may be a signaling for indicating the activation of the duplication transmission mode (duplication activation); and the fourteenth signaling may be a signaling for configuring the duplication transmission mode (duplication activation indication).

The data communication method provided according to the above-mentioned embodiments of the application will be described in detail below.

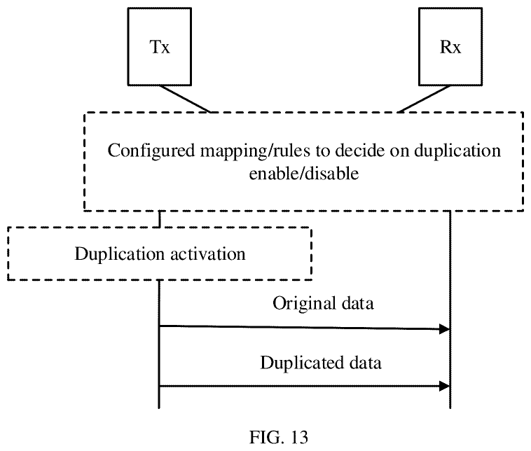

Application example 1: in a multicast/broadcast communication scenario, if the UE is out of network coverage, or if the UE is in coverage but in an idle or inactive state, as illustrated in FIG. 13, the method may include the following.

1. Both the receiving UE and the transmitting UE may perform the following processing:
1) whether the duplication transmission mode is enabled or disabled may be determined according to the first rule (such as the predefined mapping relationship or rule);
2) the first rule may be defined according to each service type/QoS flow/L2 identifier/logical channel/Tx protocol/data communication type (unicast or broadcast)/priority/carrier/resource pool/CBR level;
3) the transmitting UE may determine whether the duplication communication may be performed according to the first rule;
4) the receiving UE may determine whether the reception of the duplication communication may be performed according to the first rule;
5) the first rule may be pre-configured, indicated by the network through the system message, or indicated by the upper layer.

2. For activating the duplication transmission mode, the transmitting UE may perform the following processing:
if the first rule determines that a data communication is a data communication when the duplication transmission mode is enabled, the duplication transmission mode may be activated automatically/by default to perform the duplication.

The duplication transmission mode may be activated under the first condition, and the first condition may include the following:
determining whether the data priority satisfies the condition (greater than the set priority requirement);
determining whether the CBR measurement value of the resource pool satisfies the condition (lower than the set threshold);
determining whether the SL-RSRP measurement value (herein, the measurement value may be an average value, a maximum value, a minimum value, or any value of a plurality of multicast/broadcast measurement values) satisfies the condition (higher than the minimum threshold and/or lower than the maximum threshold);
for multicast, no PSFCH feedback being received for N consecutive times; (N may be implemented by network configuration, fixed value, or UE customization);
for multicast, no ACK feedback being received for N consecutive times;
receiving the activation indication from the upper layer;
for multicast or broadcast, the receiving UE activating through the signaling (such as PSFCH or MAC CE). In this case, the receiving UE may trigger the activation in a case where the RSRP measurement value satisfies the condition (higher than the minimum threshold and/or lower than the maximum threshold) or in a case where N consecutive reception failures occur.

3. For data communication, the transmitting UE may perform the following processing:
1) carrier(s) and resource(s) for source data/duplicated data may be selected according to the carrier selection mechanism/configuration to implement data communication, including first data (such as source data) and second data (such as duplicated data);
   the source data and the duplicated data may be transmitted on the same carrier or on different carriers;
   carriers supporting source and duplicated data may be defined;
2) during data communication, the correspondence between the first data (such as source data) and the second data (such as duplicated data) may satisfy the following second condition;
   the duplication relationship between the source data and the duplicated data may be indicated by carrier mapping, that is, the data on carrier 2 are duplicated from the data on carrier 1;
   the duplication relationship between the source data and the duplicated data may be indicated by the logical channel (LCH) identifier (ID) mapping, that is, the data on LCH ID 2 are duplicated from the data on LCH ID 1;
   the duplication relationship between the source data and the duplicated data may be indicated explicitly, that is, the duplicated data packet carries an indication of the duplicated data, which may be carried in the sidelink control information (SCI), or the MAC header, or the MAC-CE, and may indicate the duplicated data and/or the duplicated data from which logical channel;
   the second condition (such as the duplication relationship) is a mapping relationship between the source data and the duplicated data, which may be achieved by setting a fixed mapping relationship/a network configured mapping relationship/a pre-configured mapping relationship/a UE customized mapping relationship.

4. The receiving UE may perform the following processing:
1) according to the carrier selection mechanism/configuration, the carrier to be sensed may be selected and the first data (such as source data) transmitted on the current carrier may be identified;
2) duplication communication packets may be identified and received through mapping rules (carrier or logical channel)/or indications in received packets.

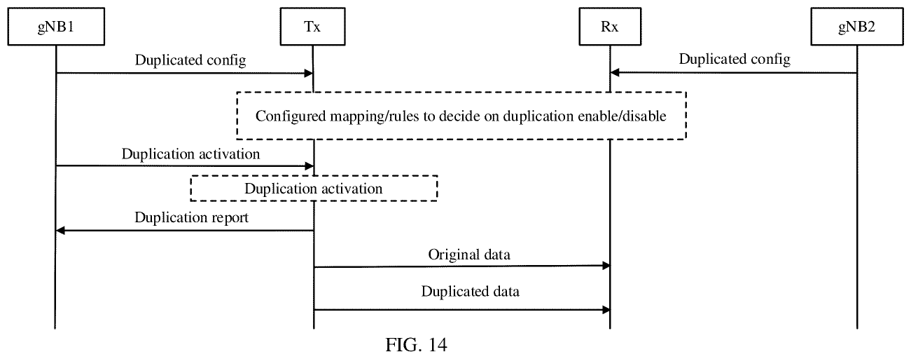

Application example 2: in a multicast/broadcast communication scenario, if the UE is in coverage and in a connected (CONNECTED) state and/or mode 1, as illustrated in FIG. 14, the method may include the following.

1. Both the receiving UE and the transmitting UE may perform the following processing:
1) whether the duplication transmission mode is enabled or disabled may be determined according to the first rule (such as the predefined mapping relationship or rule);
2) the first rule may be defined according to each service type/QoS flow/L2 identifier/logical channel/Tx protocol/data communication type (unicast or broadcast)/priority/carrier/resource pool/CBR level;
3) the transmitting UE may determine whether the duplication communication may be performed according to the first rule;
4) the receiving UE may determine whether the reception of the duplication communication may be performed according to the first rule;
5) the first rule may be pre-configured, indicated by the network through the system message, indicated by the network through the RRC signaling, or indicated by the upper layer.

2. For activating the duplication transmission mode, the transmitting UE may perform the following processing:
if the first rule determines that a data communication is a data communication when the duplication transmission mode is enabled, the duplication transmission mode may be activated automatically/by default to perform the duplication.

The duplication transmission mode may be activated under the first condition, and the first condition may include the following:
determining whether the data priority satisfies the condition (greater than the set priority requirement);
determining whether the CBR measurement value of the resource pool satisfies the condition (lower than the set threshold);
determining whether the RSRP measurement value (herein the measurement value may be an average value, a maximum value, a minimum value, or any value of a plurality of multicast/broadcast measurement values) satisfies the condition (higher than the minimum threshold and/or lower than the maximum threshold);
for multicast, no PSFCH feedback being received for N consecutive times; (N may be implemented by network configuration, fixed value, or implemented by the UE);
for multicast, no ACK feedback being received for N consecutive times;
receiving the activation indication from the upper layers;
for multicast or broadcast, the receiving UE activating by the signaling (such as PSFCH or MAC CE). In this case, the receiving UE may trigger the activation in a case where the RSRP measurement value satisfies the condition (higher than the minimum threshold and/or lower than the maximum threshold) or in a case where N consecutive reception failures occur or the network of the receiving UE indicates the activation;
receiving the indication from the network to activate the duplication communication (which may be MAC CE or RRC signaling).

After activating the duplication transmission mode, the transmitting UE may report the duplication communication condition to the network device. The reporting of the duplication communication condition may occur at any time before or after the network device transmits the duplication communication activation/configuration;
reporting by the RRC signaling to indicate the target L2 ID and logical channel for duplication communication;
reporting by the MAC CE to indicate the target L2 ID and logical channel for duplication communication (it may be a new MAC CE or an existing MAC CE such as adding indication information in buffer status report (BSR)).

3. For data communication, the transmitting UE may perform the following processing:
1) carrier(s) and resource(s) for source data/duplicated data may be selected according to the carrier selection mechanism/configuration to implement data communication, including first data (such as source data) and second data (such as duplicated data);
   the source data and the duplicated data may be transmitted on the same carrier or on different carriers;
   carriers supporting source and duplicated data may be defined;
2) during data communication, the correspondence between the first data (such as source data) and the second data (such as duplicated data) may satisfy the following second condition;
   the duplication relationship between the source data and the duplicated data may be indicated by carrier mapping, that is, the data on carrier 2 are duplicated from the data on carrier 1;
   the duplication relationship between the source data and the duplicated data may be indicated by the logical channel (LCH) identifier (ID) mapping, that is, the data on LCH ID 2 are duplicated from the data on LCH ID 1;
   the duplication relationship between the source data and the duplicated data may be indicated explicitly, that is, the duplicated data packet carries an indication of the duplicated data, which may be carried in the SCI, or the MAC header, or the MAC-CE, and may indicate the duplicated data and/or the duplicated data from which logical channel;
   the second condition (such as the duplication relationship) is a mapping relationship between the source data and the duplicated data, which may be achieved by setting a fixed mapping relationship/a network configured mapping relationship/a pre-configured mapping relationship/a UE customized mapping relationship.

4. The receiving UE may perform the following processing:
1) according to the carrier selection mechanism/configuration, the carrier to be sensed may be selected and the first data transmitted on the current carrier may be identified;
2) duplication communication packets may be identified and received through mapping rules (carrier or logical channel)/or indications in received packets.

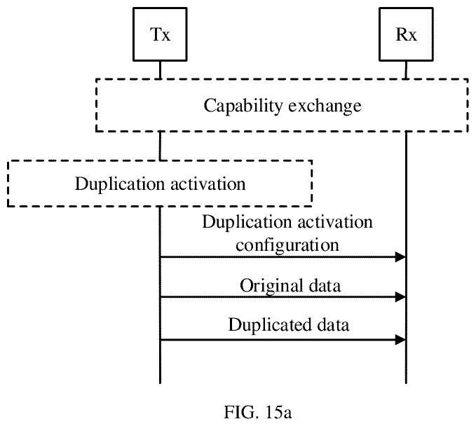

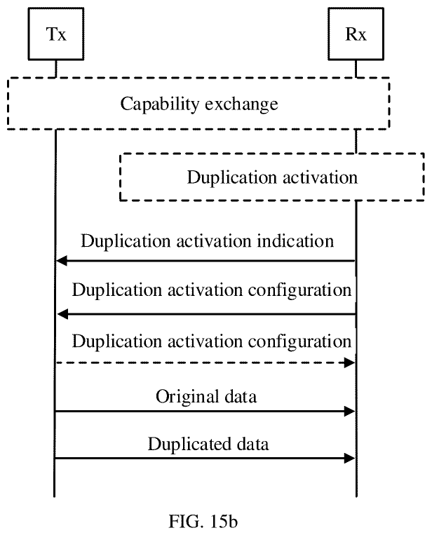

Application example 3: in a unicast communication scenario, if the UE is out of network coverage, or if the UE is in coverage but in an idle or inactive state, as illustrated in FIG. 15a-FIG. 15b, the method may include the following.

1. Both the receiving UE and the transmitting UE may perform the following processing:
in addition to determining whether the duplication transmission mode is enabled or disabled according to the first rule (such as the predefined mapping relationship or rule) in the above application examples, signaling interaction/configuration (such as capability interaction) between UEs may also be enabled.

2. For activating the duplication transmission mode, the transmitting UE as illustrated in FIG. 15a may perform the following processing:
1) if the data communication is determined to be a data communication when the duplication transmission mode is enabled through the first rule and the capability interaction, the duplication transmission mode may be activated automatically/by default to perform the duplication.

The duplication transmission mode may be activated under the first condition, and the first condition may include the following:
determining whether the data priority satisfies the condition (greater than the set priority requirement);
determining whether the CBR measurement value of the resource pool satisfies the condition (lower than the set threshold);
determining whether the RSRP measurement value satisfies the condition (higher than the minimum threshold and/or lower than the maximum threshold);
for multicast, no PSFCH feedback being received for N consecutive times; (N may be implemented by network configuration, fixed value, or UE);
for multicast, no ACK feedback being received for N consecutive times;
receiving the activation indication from the upper layer;
for multicast, the receiving UE activating through the signaling (such as PSFCH). In this case, the receiving UE may trigger the activation in a case where the RSRP measurement value satisfies the condition (higher than the minimum threshold and/or lower than the maximum threshold) or in a case where N consecutive reception failures occur.

3. The above-mentioned activation of the duplication transmission mode may also be performed in the receiving UE. For activating the duplication transmission mode, the receiving UE illustrated in FIG. 15b may perform the following processing:
1) if the data communication is determined to be a data communication when the duplication transmission mode is enabled through the first rule and the capability interaction, the duplication transmission mode may be activated automatically/by default to perform the duplication.

The duplication transmission mode may be activated under the first condition, and the first condition may include the following:
determining whether the data priority satisfies the condition (greater than the set priority requirement);
determining whether the CBR measurement value of the resource pool satisfies the condition (lower than the set threshold);
determining whether the RSRP measurement value satisfies the condition (higher than the minimum threshold and/or lower than the maximum threshold);
receiving the activation indication from the upper layer;
N consecutive reception failures triggering the activation.

4. For data communication, including data communication of first data (such as source data) and second data (such as duplicated data), the transmitting UE illustrated in FIG. 15a may perform the following processing:
1) the transmitting UE may transmit the duplication communication activation and duplication communication related configuration to the receiving UE, including the mapping rule between the duplicated data and the source data, bearer configuration, etc.
   the activation information may be MAC CE or RRC or physical layer information, and the configuration information may be RRC information;
2) carrier(s) and resource(s) for source data/duplicated data may be selected according to the carrier selection mechanism/configuration;
   the source data and the duplicated data may be transmitted on the same carrier or on different carriers;
   carriers supporting source and duplicated data may be defined;
3) source data and duplicated data may be transmitted, the corresponding relationship between the source data and the duplicated data may satisfy the following second condition;
   the duplication relationship between the source data and the duplicated data may be indicated by carrier mapping, that is, the data on carrier 2 are duplicated from the data on carrier 1;
   the duplication relationship between the source data and the duplicated data may be indicated by the logical channel (LCH) identifier (ID) mapping, that is, the data on LCH ID 2 are duplicated from the data on LCH ID 1;
   the duplication relationship between the source data and the duplicated data may be indicated explicitly, that is, the duplicated data packet carries an indication of the duplicated data, which may be carried in the SCI, or the MAC header, or the MAC-CE, and may indicate the duplicated data and/or the duplicated data from which logical channel;
   the duplication relationship between the source data and the duplicated data may be configured through PC5-RRC;
   the second condition (such as the duplication relationship) is a mapping relationship between the source data and the duplicated data, which may be achieved by setting a fixed mapping relationship/a network configured mapping relationship/a pre-configured mapping relationship/a UE customized mapping relationship.

5. Accordingly, the receiving UE as illustrated in FIG. 15a may perform the following processing:
1) the carrier to be sensed may be selected based on the carrier selection mechanism/configuration from the transmitting UE;
2) duplication communication packets may be identified and received through mapping rules (carrier or logical channel)/or indications in received packets/or indications from the transmitting UE.

6. The above data communication may also be performed at the receiving UE, including the data communication of the first data (such as the source data) and the second data (such as the duplicated data). For activating the duplication transmission mode, the receiving UE illustrated in FIG. 15b may perform the following processing:
1) the receiving UE may transmit the duplication communication activation and duplication communication related configuration to the transmitting UE, including the mapping rule between the duplicated data and the source data, bearer configuration, etc.
   the activation information may be MAC CE or RRC or physical layer information, and the configuration information may be RRC information;
alternatively, the receiving UE may transmit the duplication communication activation to the transmitting UE, and the transmitting UE may configure the duplication communication related configuration after receiving the activation information;
   the activation information may be MAC CE or RRC or physical layer information, and the configuration information may be RRC information;
2) the carrier to be sensed may be selected based on the carrier selection mechanism/configuration from the transmitting UE;
3) duplication communication packets may be identified and received through mapping rules (carrier or logical channel)/or indications in received packets/or indications from the transmitting UE or its own implementation.

7. Accordingly, the transmitting UE as illustrated in FIG. 15b may perform the following processing:
1) carrier(s) and resource(s) for the source data/duplicated data may be selected according to the carrier selection mechanism/configuration;
   the source data and the duplicated data may be transmitted on the same carrier or on different carriers;
   carriers supporting source and duplicated data may be defined;
2) source data and duplicated data may be transmitted, the corresponding relationship between the source data and the duplicated data may satisfy the following second condition;
   the duplication relationship between the source data and the duplicated data may be indicated by carrier mapping, that is, the data on carrier 2 are duplicated from the data on carrier 1;
   the duplication relationship between the source data and the duplicated data may be indicated by the logical channel identifier mapping, that is, the data on LCH ID 2 are duplicated from the data on LCH ID 1;
   the duplication relationship between the source data and the duplicated data may be explicitly indicated, that is, the duplicated data packet carries an indication of the duplicated data, which may be carried in the SCI or the MAC packet header, and may indicate the duplicated data and/or the duplicated data from which logical channel;
   the duplication relationship between the source data and the duplicated data may be configured through PC5-RRC;
   the second condition (such as the duplication relationship) is a mapping relationship between the source data and the duplicated data, which may be achieved by setting a fixed mapping relationship/a network configured mapping relationship/a pre-configured mapping relationship/a UE customized mapping relationship.

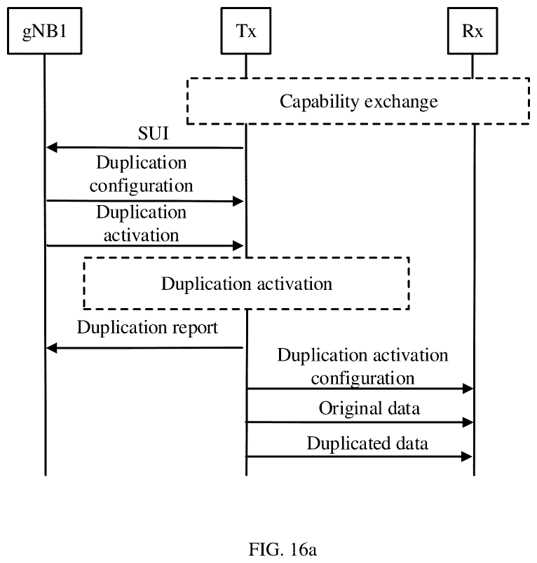

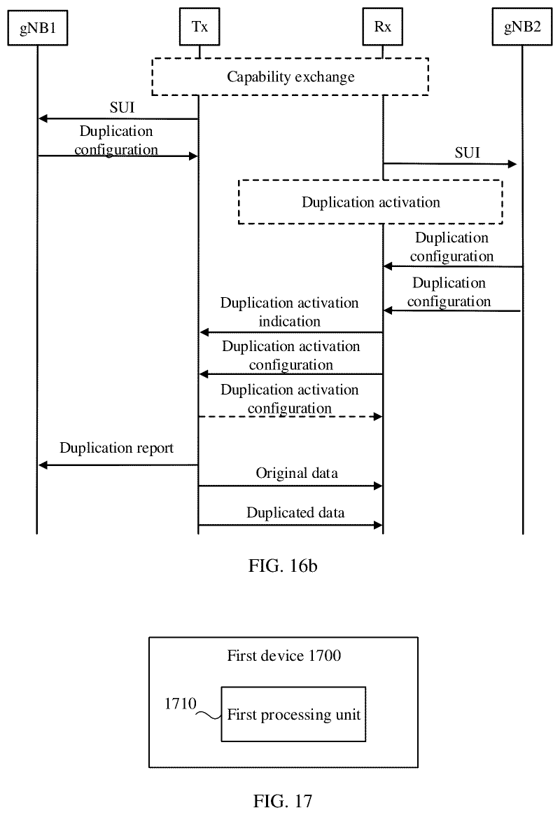

Application example 4: in a unicast communication scenario, if the UE is in network coverage and in a CONNECTED state, as illustrated in FIG. 16a-FIG. 16b, the method may include the following.

1. Both the receiving UE and the transmitting UE may perform the following processing:
in addition to determining whether the duplication transmission mode is enabled or disabled according to the first rule (such as the predefined mapping relationship or rule) in the above application examples, signaling interaction/configuration (such as capability interaction) between UEs may also be enabled.

2. For activating the duplication transmission mode, the transmitting UE as illustrated in FIG. 16a may perform the following processing:
1) if the data communication is determined to be a data communication when the duplication transmission mode is enabled through the first rule and the capability interaction, an RRC message is reported to the network device, including that the peer UE supports duplication communication or is about to perform duplication communication or request, and the duplication transmission mode may be activated automatically/by default for duplication communication.

The duplication transmission mode may be activated under the first condition, and the first condition may include the following:
determining whether the data priority satisfies the condition (greater than the set priority requirement);
determining whether the CBR measurement value of the resource pool satisfies the condition (lower than the set threshold);
determining whether the RSRP measurement value satisfies the condition (higher than the minimum threshold and/or lower than the maximum threshold);
no PSFCH feedback being received for N consecutive times; (N may be implemented by network configuration, fixed value, or UE);
no ACK feedback being received for N consecutive times;
receiving the activation indication from the upper layer;
receiving the activation indication from the network.

3. The above-mentioned activation of the duplication transmission mode may also be performed in the receiving UE. For activating the duplication transmission mode, the receiving UE illustrated in FIG. 16b may perform the following processing:
1) if a data communication is determined to be a data communication when the duplication transmission mode is enabled through the first rule and the capability interaction, an RRC message is reported to the network device, including that the peer UE supports duplication communication or is about to perform duplication communication or request, and the duplication transmission mode may be activated automatically/by default to perform duplication communication.

The duplication transmission mode may be activated under the first condition, and the first condition may include the following:
determining whether the data priority satisfies the condition (greater than the set priority requirement);
determining whether the CBR measurement value of the resource pool satisfies the condition (lower than the set threshold);
determining whether the RSRP measurement value satisfies the condition (higher than the minimum threshold and/or lower than the maximum threshold);
receiving the activation indication from the upper layer;
N consecutive reception failures triggering the activation.

4. For data communication, including data communication of first data (such as source data) and second data (such as duplicated data), the transmitting UE illustrated in FIG. 16a may perform the following processing:
1) the transmitting UE may receive the duplication communication activation and configuration from the network device, and transmit the duplication communication activation and duplication communication related configuration to the receiving UE according to the received configuration, including the mapping rule between the duplicated data and the source data, the bearer configuration, etc.;
   the activation information may be MAC CE or RRC or physical layer information, and configuration information may be RRC information;
2) the transmitting UE reports the duplication condition to the network device;
   it may be reported by the RRC signaling to indicate the target L2 ID and logical channel for duplication communication;
   it may be reported by the MAC CE to indicate the target L2 ID and logical channel for duplication communication (it may be a new MAC CE or an existing MAC CE such as adding indication information in BSR);
3) carrier(s) and resource(s) for source data/duplicated data may be selected according to the carrier selection mechanism/configuration;
   the source data and the duplicated data may be transmitted on the same carrier or on different carriers;
   carriers supporting source and duplicated data may be defined;
4) source data and duplicated data may be transmitted, the corresponding relationship between the source data and the duplicated data may satisfy the following second condition;
   the duplication relationship between the source data and the duplicated data may be indicated by carrier mapping, that is, the data on carrier 2 are duplicated from the data on carrier 1;
   the duplication relationship between the source data and the duplicated data may be indicated by the logical channel identifier mapping, that is, the data on LCH ID 2 are duplicated from the data on LCH ID 1;
   the duplication relationship between the source data and the duplicated data may be explicitly indicated, that is, the duplicated data packet carries an indication of the duplicated data, which may be carried in the SCI, or the MAC header, or the MAC-CE, and may indicate the duplicated data and/or the duplicated data from which logical channel;
   the duplication relationship between the source data and the duplicated data may be configured through PC5-RRC;
   the second condition (such as the duplication relationship) is a mapping relationship between the source data and the duplicated data, which may be achieved by setting a fixed mapping relationship/a network configured mapping relationship/a pre-configured mapping relationship/a UE customized mapping relationship.

5. Accordingly, the receiving UE as illustrated in FIG. 16a may perform the following processing:
1) the carrier to be sensed may be selected based on the carrier selection mechanism/configuration from the transmitting UE;
2) duplication communication data packets may be identified and received through mapping rules (carrier or logical channel)/or indications in received packets/or indications from the transmitting UE.

6. The above data communication may also be performed at the receiving UE, including the data communication of the first data (such as the source data) and the second data (such as the duplicated data). For activating the duplication transmission mode, the receiving UE illustrated in FIG. 16b may perform the following processing:
1) the receiving UE may receive the duplication communication activation and duplication communication related configuration from the network device, and transmit the duplication communication activation and duplication communication related configuration to the transmitting UE according to the received configuration, including the mapping rule between the duplicated data and the source data, bearer configuration, etc.;
   the activation information may be MAC CE or RRC or physical layer information, and the configuration information may be RRC information;
alternatively, the receiving UE may transmit the duplication communication activation to the transmitting UE, and the transmitting UE may configure the duplication communication related configuration after receiving the activation information;
   Before this, the transmitting UE may also report to the network device that the peer UE supports duplication communication or is about to perform duplication communication, etc.; and the transmitting UE may receive the duplication communication related configuration from the network device, and transmit the configuration information to the receiving UE according to the received configuration;
   the activation information may be MAC CE or RRC or physical layer information, and the configuration information may be RRC information;
2) the carrier to be sensed may be selected based on the carrier selection mechanism/configuration from the transmitting UE;
3) duplication communication data packets may be identified and received through mapping rules (carrier or logical channel)/or indications in received packets/or indications from the transmitting UE or its own implementation.

7. Accordingly, the transmitting UE as illustrated in FIG. 16b may perform the following processing:
1) the transmitting UE may report the duplication condition to the network device;
   it may be reported by the RRC signaling to indicate the target L2 ID and logical channel for duplication communication;
   it may be reported by the MAC CE to indicate the target L2 ID and logical channel for duplication communication (it may be a new MAC CE or an existing MAC CE such as adding indication information in BSR)
2) carrier(s) and resource(s) for source data/duplicated data may be selected according to the carrier selection mechanism/configuration;
   the source data and the duplicated data may be transmitted on the same carrier or on different carriers;
   carriers supporting source and duplicated data may be defined;
3) source data and duplicated data may be transmitted, the corresponding relationship between the source data and the duplicated data may satisfy the following second condition;
   the duplication relationship between the source data and the duplicated data may be indicated by carrier mapping, that is, the data on carrier 2 are duplicated from the data on carrier 1;
   the duplication relationship between the source data and the duplicated data may be indicated by the logical channel identifier mapping, that is, the data on LCH ID 2 are duplicated from the data on LCH ID 1;
   The duplication relationship between the source data and the duplicated data may be explicitly indicated, that is, the duplicated data packet carries an indication of the duplicated data, which may be carried in the SCI or the MAC packet header, and may indicate the duplicated data and/or the duplicated data from which logical channel;
   the duplication relationship between the source data and the duplicated data may be configured through PC5-RRC;
   the second condition (such as the duplication relationship) is a mapping relationship between the source data and the duplicated data, which may be achieved by setting a fixed mapping relationship/a network configured mapping relationship/a pre-configured mapping relationship/a UE customized mapping relationship.

It should be pointed out that the above examples may be combined with various possibilities in the above-mentioned embodiments of the application, which will not be described in detail herein.

FIG. 17 is a schematic block diagram of a first device 1700 according to embodiments of the application. The first device 1700 may include a first processing unit 1710, configured to transmit first data on a sidelink in a duplication transmission mode.

In a possible implementation, the first device may further include a second processing unit configured to the duplication transmission mode is enabled or disabled according to a first rule.

The first rule is obtained through at least one of: a pre-configuration, an indication of a system message, or an indication of an upper layer.

In a possible implementation, the first rule is related to at least one of: a service type, a QoS flow, a L2 identifier, a logical channel, a Tx protocol, a data communication type, a data communication priority, a carrier, a resource pool, or a CBR level.

In a possible implementation, the first device may also include a third processing unit configured to: in a case where the duplication transmission mode is enabled, activate the duplication transmission mode. The first data may be transmitted in the duplication transmission mode on the sidelink after activating the duplication transmission mode.

In a possible implementation, the duplication transmission mode is activated in a case where the first condition is satisfied.

In some examples, the first condition may include at least one of the following:
a data communication priority being greater than a priority requirement;
a CBR measurement value of a resource pool being less than a first threshold;
an SL-RSRP measurement value being greater than a second threshold and/or less than a third threshold;
receiving an indication of an upper layer, the indication of the upper layer for activating the duplication transmission mode;
failure to receive feedback on a PSFCH for N consecutive times, where N is a positive integer greater than 1;
failure to receive an ACK feedback for N consecutive times, where N is a positive integer greater than 1; or
receiving, from a second device, a first signaling, the first signaling for indicating to activate the duplication transmission mode. For example, the first signaling may be a signaling for indicating the activation of the duplication transmission mode (duplication activation). For example, the second device may include the terminal device or the network device, and the terminal device may be the transmitting UE or the receiving UE.

In some examples, a correspondence between the second data and the first data (such as the duplication relationship between the second data and the first data) is determined through at least one of: a carrier mapping indication, a logical channel identifier mapping indication, an explicit indication, a network configuration, or a pre-configuration. In detail, it may include the following:
1) the carrier mapping indication may be used between the second data and the first data to determine the corresponding duplication relationship between the second data and the first data;
2) the logical channel identifier mapping indication may be used between the second data and the first data to determine the corresponding duplication relationship between the second data and the first data;
3) the explicit indication may be used between the second data and the first data to determine the corresponding duplication relationship between the second data and the first data.

In a possible implementation, the first device may also include a fourth processing unit configured to transmit the first data and second data on the sidelink, the second data being duplicated data, where the second data and the first data are transmitted on a same carrier or different carriers.

In a possible implementation, the first device further may include a fifth processing unit configured to:
receive a second signaling initiated by the second device; and
in response to the second signaling, configure the first data to be transmitting on the sidelink in the duplication transmission mode.

In some examples, the second signaling may include at least one of: an RRC signaling, an MAC CE, or a physical layer signaling.

In some examples, in a case where the second signaling carries the RRC signaling, the first device may also include an indication unit configured to obtain the first rule through an indication of the RRC signaling.

In a possible implementation, the first device may further include a receiving unit configured to receive the first signaling from the second device through at least one of:
in a case where an RSRP measurement value of the second device is greater than the second threshold and/or less than the third threshold, receiving, from the second device, the first signaling; or
in a case where the second device fails to receive data for N consecutive times, receiving, from the second device, the first signaling.

In some examples, the second device may be the terminal device or the network device.

In a possible implementation, the first device may also include a sixth processing unit configured to: receive a third signaling initiated by the first network device, where the third signaling is configured to carry an indication of activating the duplication transmission mode; in response to the third signaling, trigger the duplication transmission mode to enter an activated state according to the indication of activating the duplication transmission mode; and transmit a fourth signaling to the first network device, where the fourth signaling is configured to notify the first network device of the duplication condition of the first device.

In a possible implementation, the third signaling may include: the RRC signaling, the MAC CE signaling, or the physical layer signaling (such as PDCCH).

In a possible implementation, the first device may also include a seventh processing unit configured to activate the duplication transmission mode when the following first condition is satisfied.

The first condition may include: receiving a first signaling, the first signaling being configured to indicate the activation of the duplication transmission mode.

The second device transmits the first signaling based on one of the following:
the RSRP measurement value being greater than the second threshold and/or less than the third threshold;
the first signaling is configured to indicate that the second device has failed to receive data for N consecutive times; or
the first signaling is configured to indicate that the second device has received an indication initiated by the second network device to activate the duplication transmission mode.

In a possible implementation, the first device may also include an eighth processing unit configured to exchange capability information between the first device and the second device; and determine whether the duplication transmission mode is enabled or disabled according to the first rule and/or the capability information.

In a possible implementation, the capability information may include at least one of: information that the first device and/or the second device has enabled the duplication transmission mode, information that the first device and/or the second device is about to enter the duplication transmission mode, or information that the first device and/or the second device requests duplication resources.

In a possible implementation, the first device may also include a ninth processing unit configured to receive a tenth signaling transmitted by the second device, where the tenth signaling is configured to configure the duplication transmission mode; and in response to the tenth signaling, configure to transmit the first data in the duplication transmission mode on the sidelink.

In a possible implementation, the first device may also include a tenth processing unit configured to transmit a fifth signaling to the first network device after exchanging the capability information; receive a sixth signaling initiated by the first network device; and in response to the sixth signaling, configure to transmit the first data in the duplication transmission mode on the sidelink.

In a possible implementation, the capability information is carried in the fifth signaling.

The capability information may include at least one of the following information: information that the first device and/or the second device has enabled the duplication transmission mode, information that the first device and/or the second device is about to enter the duplication transmission mode, or information that the first device and/or the second device requests duplication resources.

In a possible implementation, the first device may also include an eleventh processing unit configured to receive a seventh signaling initiated by the first network device, where the seventh signaling is configured to carry an indication of activating the duplication transmission mode; in response to the seventh signaling, trigger the duplication transmission mode to enter an activated state according to the indication of activating the duplication transmission mode; transmit an eighth signaling to the first network device, where the eighth signaling is configured to notify the first network device of the duplication condition of the first device.

In a possible implementation, in a case where the sixth signaling carries the indication of the RRC signaling, the first device may also include: obtaining the first rule through the indication of the RRC signaling.

In a possible implementation, the first device may also include a twelfth processing unit configured to activate the duplication transmission mode in a case where the first device satisfies the following first condition.

The first condition may include: receiving a first signaling, where the first signaling is configured to indicate that after the duplication transmission mode is activated, the RSRP measurement value of the second device is greater than the second threshold and/or less than the third threshold, or the first signaling is configured to indicate that the second device has failed to receive data for N consecutive times, or the first signaling is configured to indicate that the second device has received an indication initiated by the second network device to activate the duplication transmission mode.

The first device 1700 according to embodiments of the application may implement the corresponding functions of the first device according to the aforementioned method embodiments. The processes, functions, implementation manners, and beneficial effects corresponding to each module (sub-module, unit, or component, etc.) in the first device 1700 may be found in the corresponding description in the above method embodiments, and will not be repeated herein. It should be noted that the functions described in the various modules (sub-modules, units, or components, etc.) in the first device 1700 according to embodiments of the application may be implemented by different modules (sub-modules, units, or components, etc.) or by the same module (sub-module, unit, or component, etc.).

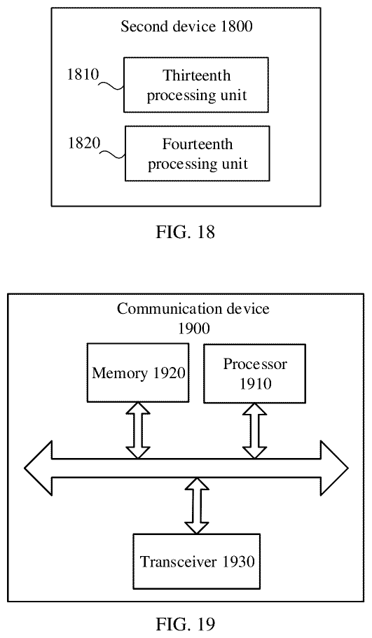

FIG. 18 is a schematic block diagram of a second device 1800 according to embodiments of the application. The network device 1800 may include: a thirteenth processing unit 1810 configured to perform carrier sensing on a sidelink; and a fourteenth processing unit 1820 configured to receive first data transmitted on the current carrier. The first data are data transmitted by the first device in a duplication transmission mode.

In a possible implementation, the thirteenth processing unit is configured to perform the carrier sensing according to a carrier selection and/or a carrier configuration.

In a possible implementation, the fourteenth processing unit is configured to identify the first data transmitted on the current carrier according to a first rule; where the first rule is obtained through at least one of: a pre-configuration, an indication of a system message, an indication of an RRC signaling, or an indication of an upper layer.

In a possible implementation, the first rule is related to at least one of: a service type, a QoS flow, a L2 identifier, a logical channel, a Tx protocol, a data communication type, a data communication priority, a carrier, a resource pool, or a CBR level.

In a possible implementation, the second device may further include a fifteenth processing unit configured to transmit a first signaling to the first device, the first signaling for indicating to activate the duplication transmission mode.

In a possible implementation, the first signaling is transmitted in a case where the RSRP measurement value of the second device is greater than a second threshold and/or less than a third threshold.

In a possible implementation, the first signaling is transmitted when/after the second device fails to receive data for N consecutive times.

In a possible implementation, the second device may further include a transmitting unit configured to transmit a second signaling, the second signaling for configuring the duplication transmission mode.

In some examples, the second signaling may include at least one of: the RRC signaling, the MAC CE, or the physical layer signaling.

In a possible implementation, the second device may further include a sixteenth processing unit configured to receive a ninth signaling initiated by the second network device, where the ninth signaling is configured to configure the duplication transmission mode; and in response to the ninth signaling, transmit the tenth signaling to the first device, where the tenth signaling is configured to configure the duplication transmission mode.

In a possible implementation, the second device may further include a seventeenth processing unit configured to exchange capability information between the second device and the first device, and determine whether the duplication transmission mode is enabled or disabled according to the first rule and/or the capability information.

In some examples, the capability information may include at least one of: information that the first device and/or the second device has enabled the duplication transmission mode, information that the first device and/or the second device is about to enter the duplication transmission mode, or information that the first device and/or the second device requests duplication resources.

In a possible implementation, the second device may further include a nineteenth processing unit configured to transmit an eleventh signaling to the first device, where the eleventh signaling is configured to indicate the activation of the duplication transmission mode; and/or, transmit a twelfth signaling to the first device, where the twelfth signaling is configured to configure the duplication transmission mode.

In a possible implementation, the second device may further include a twentieth processing unit configured to receive a thirteenth signaling transmitted by the second network device, where the thirteenth signaling is configured to indicate the activation of the duplication transmission mode; and/or, receive a fourteenth signaling transmitted by the second network device, where the fourteenth signaling is configured to configure the duplication transmission mode.

The second device 1800 according to embodiments of the application may implement the corresponding functions of the second device according to the aforementioned method embodiments. The processes, functions, implementation manners, and beneficial effects corresponding to each module (sub-module, unit, or component, etc.) in the second device 1800 may be found in the corresponding description in the above method embodiments, and will not be repeated herein. It should be noted that the functions described in the various modules (sub-modules, units, or components, etc.) in the second device 1800 according to embodiments of the application may be implemented by different modules (sub-modules, units, or components, etc.) or by the same module (sub-module, unit, or component, etc.).

FIG. 19 is a schematic block diagram of a communication device 1900 according to embodiments of the application. The communication device 1900 may include a processor 1910. The processor 1910 may call a computer program from a memory and execute the computer program to enable the communication device 1900 to implement the method according to embodiments of the application.

Alternatively, the communication device 1900 may further include a memory 1920. The processor 1910 may call a computer program from the memory 1920 and execute the computer program to enable the communication device 1900 to implement the method according to embodiments of the application.

The memory 1920 may be a separate device independent of the processor 1910 or may be integrated into the processor 1910.

Alternatively, the communication device 1900 may further include a transceiver 1930. The processor 1910 may control the transceiver 1930 to communicate with other devices, such as transmit information or data to other devices, or receive information or data transmitted by other devices.

The transceiver 1930 may include a transmitter and a receiver. The transceiver 1930 may further include an antenna and the number of the antenna may be one or more.

Alternatively, the communication device 1900 may be the first device according to embodiments of the application, and the communication device 1900 may implement the corresponding processes implemented by the first device in each method according to embodiments of the application, which will not be repeated herein for the sake of brevity.

Alternatively, the communication device 1900 may be the second device according to embodiments of the application, and the communication device 1900 may implement the corresponding processes implemented by the second device in each method according to embodiments of the application, which will not be repeated herein for the sake of brevity.

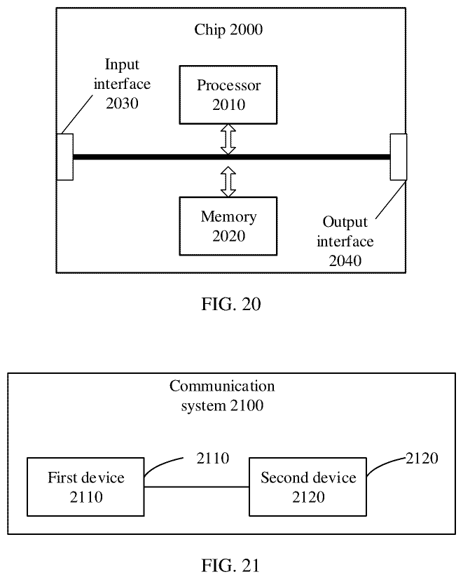

FIG. 20 is a schematic block diagram of a chip 2000 according to embodiments of the application. The chip 2000 may include a processor 2010. The processor 2010 may call a computer program from a memory and execute the computer program to implement the method according to embodiments of the application.

Alternatively, the chip 2000 may further include a memory 2020. The processor 2010 may call a computer program from the memory 2020 and execute the computer program to implement the method performed by the first device or the second device, according to embodiments of the application.

The memory 2020 may be a separate device independent of the processor 2010 or may be integrated into the processor 2010.

Alternatively, the chip 2000 may further include an input interface 2030. The processor 2010 may control the input interface 2030 to communicate with other devices or chips, such as obtain information or data transmitted by other devices or chips.

Alternatively, the chip 2000 may further include an output interface 2040. The processor 2010 may control the output interface 2040 to communicate with other devices or chips, such as output information or data to other devices or chips.

Alternatively, the chip may be applicable to the first device according to embodiments of the application, and the chip may implement the corresponding processes implemented by the first device in each method according to embodiments of the application, which will not be repeated herein for the sake of brevity.

Alternatively, the chip may be applicable to the second device according to embodiments of the application, and the chip may implement the corresponding processes implemented by the second device in each method according to embodiments of the application, which will not be repeated herein for the sake of brevity.

The chips applicable to the first device and the second device may be the same chip or different chips.

It should be understood that the chip mentioned according to embodiments of the application may also be called a system-level chip, a system chip, a chip system, or a system-on-chip chip, etc.

The processor mentioned above may be a general-purpose processor, a digital signal processor (DSP), a field programmable gate array (FPGA), an application specific integrated circuit (ASIC) or other programmable logic devices, a transistor logic device, a discrete hardware component, etc. The general-purpose processor mentioned above may be a microprocessor or any conventional processor.

The above-mentioned memory may be a volatile memory or a nonvolatile memory, or both volatile and nonvolatile memories. The nonvolatile memory may be a read-only memory (ROM), a programmable read-only memory (PROM), an erasable programmable read-only memory (EPROM), an electrically erasable programmable read-only memory (EEPROM), a flash memory, etc. The volatile memory may be a random access memory (RAM).

It should be understood that the above-mentioned memory is exemplary but not restrictive. For example, the memory according to embodiments of the application may also be a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synch link DRAM, SLDRAM), a direct memory bus random access memory (Direct Rambus RAM, DR RAM), etc. That is, the memory according to embodiments of the application may intended to include but be not limited to these and any other suitable types of memory.

FIG. 21 is a schematic block diagram of a communication system 2100 according to embodiments of the application. The communication system 2100 may include a first device 2110 and a second device 2120. The first device 2110 may include a first processing unit 2110 configured to transmit first data in a duplication transmission mode on a sidelink for the first device. The second device 2120 may include: a thirteenth processing unit configured to perform carrier sensing on a sidelink for the second device; and a fourteenth processing unit configured to receive first data transmitted on the current carrier for the second device.

The computer instructions can be stored in a computer-readable storage medium or transmitted from one computer-readable storage medium to another via wired (e.g., coaxial cable, optical fiber, DSL) or wireless (e.g., infrared, wireless, microwave) means. The computer-readable storage medium may be any accessible medium for a computer or a data storage device such as a server or data center, which includes one or more available media. Available media may include magnetic media (e.g., floppy disks, hard disks, magnetic tapes), optical media (e.g., DVDs), or semiconductor media (e.g., SSDs).

In the above embodiments, all or part of them may be implemented through software, hardware, firmware, or any combination thereof. When implemented using software, all or part of implementations may be in a form of a computer program product. The computer program product may include one or more computer instructions. When the computer program instructions are loaded and executed on a computer, they generate the processes or functions described in the embodiments of this application, either in whole or in part. The computer may be a general-purpose computer, a specialized computer, a computer network, or any other programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center via wired (e.g., coaxial cable, optical fiber, digital subscriber line (DSL)) or wireless (e.g., infrared, wireless, microwave, etc.). The computer-readable storage medium may be any available medium that may be accessed by a computer or may be a data storage device such as a server or a data center that includes one or more available media. The available medium may be a magnetic medium (e.g., a floppy disk, a hard disk, a magnetic tape), an optical medium (e.g., a DVD), a semiconductor medium (e.g., a solid state disk (SSD)), or the like.

It should be understood that in the various embodiments of the application, the serial numbers assigned to the processes do not necessarily indicate the execution order. The execution order of each process should be determined by its function and internal logic, and should not be considered as a limitation on the implementation according to the embodiments of the application.

Those skilled in the art may clearly understand that, for the sake of convenience and brevity in description, the specific working processes of the systems, devices and units described above may refer to the corresponding processes in the aforementioned method embodiments and will not be repeated herein.

The above description is only a specific implementation manner of the application, but the scope of the application is not limited thereto. Those skilled in the art may easily conceive of changes or substitutions within the technical scope disclosed herein, which should be covered by the scope of the application. Therefore, the scope of the application shall be based on the claims.

What is claimed is:

1. A data communication method, applicable to a first device, the method comprising:
transmitting, by the first device, first data on a sidelink in a duplication transmission mode.

2. The method according to claim 1, further comprising:
determining, by the first device, whether the duplication transmission mode is enabled or disabled according to a first rule,
wherein the first rule is obtained through at least one of: a pre-configuration, an indication of a system message, or an indication of an upper layer.

3. The method according to claim 2, wherein the first rule is related to at least one of: a service type, a quality of service (QoS) flow, a data link layer 2 (L2) identifier, a logical channel, a transport (Tx) protocol, a data communication type, a data communication priority, a carrier, a resource pool, or a constant bit rate (CBR) level.

4. The method according to claim 2, further comprising:
activating, by the first device, the duplication transmission mode in a case where the duplication transmission mode is enabled.

5. The method according to claim 4, wherein the activating, by the first device, the duplication transmission mode, comprises:
activating the duplication transmission mode in a case where a first condition is satisfied.

6. The method according to claim 1, wherein the transmitting, by the first device, first data on a sidelink in a duplication transmission mode, comprises:
transmitting, by the first device, the first data and second data on the sidelink, the second data being duplicated data,
wherein the second data and the first data are transmitted on a same carrier or different carriers.

7. The method according to claim 6, wherein a correspondence between the second data and the first data is determined through at least one of: a carrier mapping indication, a logical channel identifier mapping indication, an explicit indication, a network configuration, or a pre-configuration.

8. The method according to claim 6, further comprising:
receiving, by the first device, a second signaling initiated by the second device; and
configuring, by the first device in response to the second signaling, the first data to be transmitting on the sidelink in the duplication transmission mode.

9. The method according to claim 8, wherein the second signaling comprises at least one of:
a radio resource control (RRC) signaling, a medium access control control element (MAC CE), or a physical layer signaling.

10. The method according to claim 2, further comprising:
exchanging capability information between the first device and a second device; and
determining, by the first device, whether the duplication transmission mode is enabled or disabled according to the first rule and/or the capability information.

11. The method according to claim 6, wherein the second device comprises a terminal device or a network device.

12. A data communication method, applicable to a second device, the method comprising:
performing, by the second device, carrier sensing on a sidelink; and
receiving, by the second device, first data transmitted on a current carrier,
the first data being data transmitted by a first device in a duplication transmission mode.

13. The method according to claim 12, wherein the performing, by the second device, carrier sensing on a sidelink, comprises:
performing, by the second device, the carrier sensing according to a carrier selection and/or a carrier configuration.

14. The method according to claim 12, further comprising:
identifying, by the second device, the first data transmitted on the current carrier according to a first rule,
wherein the first rule is obtained through at least one of: a pre-configuration, an indication of a system message, an indication of an RRC signaling, or an indication of an upper layer; and
the first rule is related to at least one of: a service type, a QoS flow, a L2 identifier, a logical channel, a Tx protocol, a data communication type, a data communication priority, a carrier, a resource pool, or a CBR level.

15. A first device, comprising a processor and a memory, the memory being configured to store a computer program, and the processor being configured to call and execute the computer program stored in the memory, to cause the first device to perform:
transmitting first data on a sidelink in a duplication transmission mode.

16. The first device according to claim 15, wherein the processor is configured to call and execute the computer program stored in the memory to cause the first device to further perform:
determining whether the duplication transmission mode is enabled or disabled according to a first rule,
wherein the first rule is obtained through at least one of: a pre-configuration, an indication of a system message, or an indication of an upper layer.

17. The first device according to claim 16, wherein the first rule is related to at least one of: a service type, a quality of service (QoS) flow, a data link layer 2 (L2) identifier, a logical channel, a transport (Tx) protocol, a data communication type, a data communication priority, a carrier, a resource pool, or a constant bit rate (CBR) level.

18. The first device according to claim 15, wherein the transmitting first data on a sidelink in a duplication transmission mode comprises:
transmitting the first data and second data on the sidelink, the second data being duplicated data,
wherein the second data and the first data are transmitted on a same carrier or different carriers.

19. The first device according to claim 18, wherein a correspondence between the second data and the first data is determined through at least one of: a carrier mapping indication, a logical channel identifier mapping indication, an explicit indication, a network configuration, or a pre-configuration.

20. The first device according to claim 18, wherein the processor is configured to call and execute the computer program stored in the memory to cause the first device to further perform:
receiving a second signaling initiated by the second device; and
in response to the second signaling, configuring the first data to be transmitting on the sidelink in the duplication transmission mode.
